(19) United States
(12) Patent Application Publication
(10) Pub. No.: US 2009/0141359 A1
(43) Pub. Date: Jun. 4, 2009

(54) PLASTIC FILM WITH A MULTILAYERED INTERFERENCE COATING

(75) Inventors: Anette BERNI, Kashofen (DE); Martin MENNIG, Quierschied (DE); Peter W. OLIVEIRA, Saarbrucken (DE); Helmut SCHMIDT, Saarbrucken-Gudingen (DE)

Correspondence Address: GREENBLUM & BERNSTEIN, P.L.C., 1950 ROLAND CLARKE PLACE, RESTON, VA, 20191, US

(73) Assignee: Leibniz-Institut fuer Neue Materialien of Saarbruecken, Germany

(21) Appl. No.: 12/368,725

(22) Filed: Feb. 10, 2009

Related U.S. Application Data
(63) Continuation of application No. 10/944,741, filed on Sep. 21, 2004, now abandoned.
Application No. 10/944,741 is a continuation of application No. PCT/EP03/02988, filed on Mar. 21, 2003.

(30) Foreign Application Priority Data
Mar. 22, 2002 (DE) 102 12 961.4

(51) Int. Cl. G02B 5/28; B05D 5/06; B29D 7/01; B32B 5/22; G02B 1/11; B32B 9/00; B29D 1/00

(52) U.S. Cl. 359/589; 428/414; 428/325; 428/216; 428/412; 427/163.4; 977/776; 977/779

(57) ABSTRACT

A polymer film with an optical interference system. The optical interference system comprises at least two layers of different refractive index, which layers comprise nanoscale inorganic particles having organic surface groups that are polymerizable and/or polycondensable. The layers are at least partially crosslinked through the organic surface groups.

### CROSS-REFERENCE TO RELATED APPLICATIONS

The present application is a continuation of U.S. application Ser. No. 10/944,741, filed Sep. 21, 2004, which is a continuation of International Application No. PCT/EP03/02988 filed Mar. 21, 2003, which claims priority under 35 U.S.C. § 119 of German Patent Application No. 102 12 961.4, filed Mar. 22, 2002; the entire disclosures of these three applications are expressly incorporated by reference herein in their entireties.

### BACKGROUND OF THE INVENTION

1. Field of the Invention

The invention relates to a polymer film with a multilayer interference system applied to it, to a process for producing said film, to a composite material comprising a substrate laminated with a polymer film with a multilayer interference system, and to uses of said film and of said composite material.

2. Discussion of Background Information

Films of polymeric material which carry interference layer assemblies on one side are required, for example, for specialty filters or for certain optical applications in architecture or in vehicle construction, particularly for specialty glazing, where they may be used as antireflection, NIR reflection, IR reflection or color filter layers. The polymer films with the interference layer assemblies are laminated, for example, to solid sheets of glass or plastic. Prior art interference layer assemblies comprising optical layers of high and low refractive index (λ/4 layers) are deposited by vacuum coating techniques (sputtering). With these techniques, however, the deposition rates which can be realized are low, and this is reflected in the high price of the films. Only purely inorganic layers can be applied by the sputtering technique.

Also known from are wet-chemical, sol-gel process coatings. However, it has so far not proven possible to apply these coatings to flexible polymer films, but only to rigid or solid glass substrates, such as flat glass and spectacle glass, or plastics substrates such as polycarbonate sheets. The rigid substrates have been coated using dipping or spin coating techniques, which are unsuited to the coating of flexible films.

Moreover, it is known that flexible polymer films may be provided with other functional coatings by wet-chemical methods for the purpose, for example, of producing magnetic tapes for audio or video cassettes, inkjet overhead films, or foils for surface decoration by means of hot stamping. This is done using film coating methods, examples being knife coating (doctor blade coating), slot die coating, kiss coating with spiral scrapers, meniscus coating, roll coating or reverse-roll coating. The production of multilayer optical interference systems on films with these wet-chemical coating techniques, however, is unknown.

It is desirable to provide a simple process for producing multilayer optical interference systems on polymer films, and corresponding products, without the need for complicated and thus costly vacuum coating techniques.

### SUMMARY OF THE INVENTION

The present invention provides a polymer film with a multilayer optical interference system, which system comprises at least two layers of different refractive index. Each of the at least two layers comprises nanoscale inorganic particles with organic surface groups that are polymerizable and/or polycondensable. The at least two layers are at least partially crosslinked through these organic surface groups.

In one aspect, the interference system may comprise two layers. In another aspect, it may comprise three layers.

In another aspect of the polymer film of the present invention, the nanoscale inorganic particles may comprise particles of one or more of SiO₂, TiO₂, ZrO₂, ZnO, Ta₂O₅, SnO₂, and Al₂O₃. For example, the nanoscale inorganic particles may comprise particles of SiO₂ and/or TiO₂.

In yet another aspect of the polymer film, the organic surface groups may be selected from organic radicals which comprise one or more of an acryloyl, a methacryloyl, a vinyl, an allyl and an epoxy group.

In a still further aspect, the average particle size of the inorganic particles may be not higher than 100 nm, e.g., not higher than 70 nm. By way of non-limiting example, the average particle size of the inorganic particles may be from 5 nm to 20 nm.

In another aspect of the polymer film, each of the at least two layers may have a dry film thickness of from 50 nm to 200 nm, e.g., from 100 nm to 150 nm.

In another aspect, the polymer film may comprises one or more of polyethylene, polypropylene, polyisobutylene, polystyrene, polyvinyl chloride, polyvinylidene chloride, polytetrafluoroethylene, polychlorotrifluoroethylene, poly(meth)acrylate, polyamide, polyethylene terephthalate, polycarbonate, regenerated cellulose, cellulose nitrate, cellulose acetate, cellulose triacetate (TAC), cellulose acetate butyrate and rubber hydrochloride.

In yet another aspect, the polymer film may have a residual reflection of below 0.5% in a wavelength range of between 400 nm and 650 nm and a residual reflection of below 0.3% at a wavelength of 550 nm.

The present invention also provides a polymer film which is coated with a multilayer optical interference system, which system comprises at least two partially crosslinked layers of different refractive index. Each layer is obtainable by (a) application of a coating composition which comprises nanoscale inorganic particles with organic surface groups that are polymerizable and/or polycondensable, and (b) at least partially crosslinking the applied coating composition through the organic surface groups to form the partially crosslinked layer.

In one aspect of the film, the at least two applied coating compositions may be subjected to a common heat treatment.

In another aspect, the nanoscale inorganic particles may comprise particles of SiO₂ and/or TiO₂, and/or the organic surface groups may be selected from organic radicals which comprise at least one of an acryloyl, a methacryloyl, a vinyl, an allyl and an epoxy group.

In a still further aspect, the average particle size of the inorganic particles may be not higher than 100 nm, for example, not higher than 70 nm.

The present invention also provides a composite material which comprises a substrate having the polymer film of the present invention, including the various aspects thereof, arranged thereon.

In one aspect of the composite material, the substrate may comprise a transparent substrate, for example, glass. In another aspect, the substrate may comprise a plastic material.

In yet another aspect, the substrate and the polymer film may be laminated.

The present invention also provides an antireflection system, a reflection system, a reflection filter, and a color filter, all of which comprise the polymer film of the present invention, including the various aspects thereof.

The present invention further provides a process for producing a polymer film having thereon a multilayer interference assembly which comprises at least two layers having different refractive indices. The process comprises:

(a) applying a first coating sol which comprises nanoscale inorganic particles with organic surface groups that are polymerizable and/or polycondensable on the polymer film;

(b) reacting at least a part of the organic surface groups to form a first layer which is at least partially crosslinked;

(c) applying a second coating sol which comprises nanoscale inorganic particles with organic surface groups that are polymerizable and/or polycondensable on the first layer;

(d) reacting at least a part of the organic surface groups in the second sol to form an at least partially crosslinked second layer on the first layer; optionally, repeating (c) and (d) at least one more time to produce a multilayer assembly comprising at least three at least partially crosslinked layers with different refractive indices.

In one aspect, the process may comprise a heat treatment of the multilayer assembly. By way of non-limiting example, the heat treatment may be carried out concurrently with an at least partial crosslinking of the uppermost layer of the multilayer assembly. For example, the heat treatment may be conducted at a temperature of from 80° C. to 200° C., e.g., at a temperature of from 100° C. to 160° C.

In another aspect of the process, at least one of the first and second coating sols may have a total solids content of not more than 20% by weight, e.g., not more than 15% by weight.

In yet another aspect, the at least partially crosslinked layers may be formed at a temperature of from 80° C. to 200° C., e.g., at a temperature of from 100° C. to 140° C.

In a still further aspect of the process of the present invention, the nanoscale inorganic particles may comprise particles of one or more of SiO₂, TiO₂, ZrO₂, ZnO, Ta₂O₅, SnO₂, and Al₂O₃. For example, they may comprise particles of SiO₂ and/or TiO₂.

In another aspect, the organic surface groups may be selected from organic radicals which comprise at least one of an acryloyl, a methacryloyl, a vinyl, an allyl and an epoxy group.

In yet another aspect, the average particle size of the inorganic particles may be not higher than 100 nm.

In another aspect, the coating sols may consist essentially of the nanoscale inorganic particles, one or more solvents and, optionally, one or more crosslinking initiators selected from thermal and photochemical initiators.

In another aspect of the process, the coating sols may be applied at a wet film thickness of from 0.5 μm to 20 μm.

In another aspect, the layers may be thermally crosslinked, or the layers may be crosslinked by irradiation with UV light.

In yet another aspect, the process may comprise the application of at least one of the first and second coating sols by reverse-roll coating.

As discussed above, the present invention provides a polymer film on which there has been applied a multilayer optical interference system comprising at least two layers having different refractive indices and each obtainable by crosslinking a coating composition comprising nanoscale inorganic particulate solids having polymerizable and/or polycondensable organic surface groups to form a layer which is crosslinked by way of the polymerizable and/or polycondensable organic surface groups. Each of the layers obtained is an organically modified inorganic layer.

The invention further provides a process for producing this polymer film with multilayer interference coating having at least two layers having different refractive indices, which comprises:
a) applying a coating sol comprising nanoscale inorganic particulate solids having polymerizable and/or polycondensable organic surface groups to the polymer film,
b) crosslinking the polymerizable and/or polycondensable organic surface groups of the particulate solids, to form an at least partly organically crosslinked layer,
c) applying to the at least partly organically crosslinked layer a further coating sol comprising nanoscale inorganic particulate solids having polymerizable and/or polycondensable organic surface groups and a different refractive index to the preceding coating sol,
d) crosslinking the polymerizable and/or polycondensable organic surface groups of the particulate solids to form a further, at least partly organically crosslinked layer,
e) if desired, repeating c) and d) one or more times to form further at least partly organically crosslinked layers, and
f) if desired heat-treating the layer assembly, it being possible to perform this step together with d) for the topmost layer.

A multilayer interference system is composed of at least two layers of materials having different refractive indices. A fraction of the incident light is reflected at each of the interfaces between the layers. Depending on the material and the thickness of the layers, the reflections are extinguished (negative interference) or intensified (positive interference).

Surprisingly it has been found that with the coating composition used in accordance with the invention it is possible to provide polymer films with a multilayer interference system in a wet-chemical film coating process. In accordance with the invention the desired refractive indices for each layer can be set in a targeted way by selection of the coating compositions, with the at least two layers having different refractive indices.

In the present description “nanoscale inorganic particulate solids” are in particular those having an average particle size (an average particle diameter (volume average)) of not more than 200 nm, preferably not more than 100 nm, and in particular not more than 70 nm, e.g., from 5 to 100 nm, preferably from 5 to 70 nm. One particularly preferred particle size range is from 5 to 20 nm.

The nanoscale inorganic particulate solids may be composed of any desired materials but are preferably composed of metals and in particular metal compounds such as (optionally hydrated) oxides such as ZnO, CdO, SiO₂, TiO₂, ZrO₂, CeO₂, SnO2, Al₂O₃, In₂O₃, La₂O₃, Fe₂O₃, Cu₂O, Ta₂O₅, Nb₂O₅, V₂O₅, M003 or WO₃, chalcogenides such as sulfides (e.g., CdS, ZnS, PbS, and Ag₂S), selenides (e.g., GaSe, CdSe, and ZnSe), and tellurides (e.g., ZnTe or CdTe), halides such as AgCI, AgBr, Agl, CuCl, CuBr, Cdl₂, and Pbl₂; carbides such as CdC₂ or SiC; arsenides such as AlAs, GaAs, and, GeAs; antimonides such as InSb; nitrides such as BN, AlN, Si₃N₄, and Ti₃N₄; phosphides such as GaP, InP, Zn₃P₂, and Cd₃P₂; phosphates, silicates, zirconates, aluminates, stannates, and the corresponding mixed oxides (e.g., indium-tin oxides (ITO) and those with perovskite structure such as BaTiO₃ and PbTiO₃).

The nanoscale inorganic particulate solids used in the process of the invention are preferably (optionally hydrogenated) oxides, sulfides, selenides, and tellurides of metals and mixtures thereof. Preferred in accordance with the invention are nanoscale particles of SiO₂, TiO₂, ZrO₂, ZnO, Ta₂O₅, SnO₂, and Al₂O₃ (in all modifications, especially as boehmite, AlO(OH)), and mixtures thereof. It has proven to be the case that SiO₂ and/or TiO₂ as nanoscale inorganic particulate solids for the particulate solids having polymerizable and/or polycondensable organic surface groups produce coating compositions particularly suitable for film coating. The nanoscale particles still contain reactive groups on the surfaces; for example, on the surfaces of oxide particles there are generally hydroxyl groups.

Since the nanoscale particles which can be used in accordance with the invention span a broad range of refractive indices, appropriate selection of these nanoscale particles allows the refractive index of the layer(s) to be set easily to the desired value.

The nanoscale particulate solids used in accordance with the invention may be produced conventionally: for example, by flame pyrolysis, plasma processes, gas-phase condensation processes, colloid techniques, precipitation processes, sol-gel processes, controlled nucleation and growth processes, MOCVD processes, and (micro)emulsion processes. These processes are described in detail in the literature. It is possible in particular to draw, for example, on metals (for example, after the reduction of the precipitation processes), ceramic oxidic systems (by precipitation from solution), and also salt-like systems or multicomponent systems. The multicomponent systems also include semiconductor systems.

Use may also be made of commercially available nanoscale inorganic particulate solids. Examples of commercially available nanoscale SiO₂ particles are commercial silica products, e.g., silica sols, such as the Levasils®, silica sols from Bayer AG, or fumed silicas, e.g., the Aerosil products from Degussa.

The preparation of the nanoscale inorganic particulate solids provided with polymerizable and/or polycondensable organic surface groups that are used in accordance with the invention may in principle be carried out in two different ways, namely first by surface modification of previously prepared nanoscale inorganic particulate solids and secondly by preparation of these inorganic nanoscale particulate solids using one or more compounds which possess such polymerizable and/or polycondensable groups. These two ways are discussed below and in the examples.

The organic polymerizable and/or polycondensable surface groups may comprise any groups known to those of skill in the art that are amenable to free-radical, cationic or anionic, thermal or photochemical polymerization or to thermal or photochemical polycondensation, with one or more suitable initiators and/or catalysts possibly being present. The expression “polymerization” here also includes polyaddition. The initiators and/or catalysts which may be used where appropriate for the respective groups are known to the those of skill in the art. In accordance with the invention preference is given to surface groups which possess a (meth)acryloyl, allyl, vinyl or epoxy group, with (meth)acryloyl and epoxy groups being particularly preferred. The polycondensable groups include in particular hydroxyl, carboxyl, and amino groups, by means of which ether, ester, and amide linkages can be obtained between the nanoscale particles.

As already mentioned, the polymerizable and/or polycondensable surface groups may in principle be provided in two ways. Where surface modification of previously prepared nanoscale particles is carried out, compounds suitable for this purpose are all those (preferably of low molecular mass) which on the one hand possess one or more groups which are able to react or at least interact with reactive groups present on the surface of the nanoscale particulate solids (such as OH groups, for example, in the case of oxides) and on the other hand contain at least one polymerizable and/or polycondensable group. Surface modification of the nanoscale particles may be accomplished, for example, by mixing them with suitable compounds exemplified below, where appropriate in a solvent and in the presence of a catalyst. Where the surface modifiers are silanes, it is sufficient, for example, to stir them with the nanoscale particles at room temperature for several hours.

Accordingly, the corresponding compounds may, for example, form not only covalent but also ionic (salt-like) or coordinative (complex) bonds to the surface of the nanoscale particulate solids, whereas simple interactions include, for example, dipole-dipole interactions, hydrogen bonding, and van der Waals interactions. Preference is given to the formation of covalent and/or coordinate bonds.

In accordance with the invention it is also preferred for the organic groups which are present on the surfaces of the nanoscale particles and which include the polymerizable and/or polycondensable groups to have a relatively low molecular weight. In particular, the molecular weight of the (purely organic) groups should not exceed 600 and preferably not exceed 400, more preferably not exceed 300. This does not of course rule out the compounds (molecules) containing these groups having a significantly higher molecular weight (e.g., up to 1000 or more).

Examples of organic compounds which can be used to modify the surfaces of the nanoscale inorganic particulate solids include unsaturated carboxylic acids, β-dicarbonyl compounds, e.g., β-diketones or β-carbonylcarboxylic acids, having polymerizable double bonds, ethylenically unsaturated alcohols and amines, amino acids, and epoxides and diepoxides. Compounds used with preference for surface modification are diepoxides and β-diketones.

Specific examples of organic compounds for surface modification are diepoxides such as 3,4-epoxycyclohexylmethyl 3,4-epoxycyclohexanecarboxylate, bis(3,4-epoxycyclohexyl)adipate, cyclohexanedimethanol diglycidyl ether, neopentylglycol diglycidyl ether, 1,6-hexanediol diglycidyl ether, propylene glycol diglycidyl ether, bisphenol A diglycidyl ether, bisphenol F diglycidyl ether, and unsaturated carboxylic acids such as acrylic acid and methacrylic acid, and β-diketones such as acetylacetonate.

Further particularly preferred compounds for surface modification of the nanoscale inorganic particulate solids are in particular, in the case of oxidic particles, hydrolytically condensable silanes having at least (and preferably) one nonhydrolyzable radical which possesses an polymerizable and/or polycondensable group, this being preferably a polymerizable carbon-carbon double bond or an epoxy group, in particular (meth)acryloylsilanes and epoxysilanes. Silanes of this kind preferably have the formula (I):

X—R¹—SiR²₃ (I)

in which X is CH₂═CR³—COO, CH₂═CH, epoxy, glycidyl or glycidyloxy, R³ is hydrogen or methyl, R¹ is a divalent hydrocarbon radical having 1 to 10, preferably 1 to 6, carbon atoms, which if desired contains one or more heteroatom groups (e.g., O, S, NH), which separate adjacent carbon atoms from one another, and the radicals R², identical to or different from one another, are selected from alkoxy, aryloxy, acyloxy, and alkylcarbonyl groups and also halogen atoms (especially F, Cl and/or Br).

The groups R² may be different from one another but are preferably identical. The groups R² are preferably selected from halogen atoms, C₁₋₄ alkoxy groups (e.g., methoxy, ethoxy, n-propoxy, isopropoxy and butoxy), C₆₋₁₀ aryloxy groups (e.g., phenoxy), C₁₋₄ acyloxy groups (e.g., acetoxy and propionyloxy), and C₂₋₁₀ alkylcarbonyl groups (e.g., acetyl). Particularly preferred radicals R² are C₁₋₄ alkoxy groups and especially methoxy and ethoxy groups.

The radical R¹ is preferably an alkylene group, especially one having 1 to 6 carbon atoms, such as methylene, ethylene, propylene, butylene, and hexylene, for example. If X is CH₂═CH, R¹ is preferably methylene and in this case may also simply be a bond.

X is preferably CH₂═CR³—COO (where R³ is preferably CH₃) or glycidyloxy. Accordingly, particularly preferred silanes of the formula (I) are (meth)acryloyloxyalkyltrialkoxysilanes, such as, e.g., 3-methacryloyloxypropyltrimethoxysilane and 3-methacryloyloxypropyltriethoxysilane, and glycidyloxyalkyltrialkoxysilanes, such as, e.g., 3-glycidyloxypropyltrimethoxysilane and 3-glycidyloxypropyltriethoxysilane.

Where the nanoscale inorganic particulate solids are actually prepared using one or more compounds which possess polymerizable and/or polycondensable groups it is possible to forego subsequent surface modification, although such modification is of course possible as an additional measure.

The in situ preparation of nanoscale inorganic particulate solids having polymerizable and/or polycondensable surface groups is discussed below, taking SiO₂ particles as example. For this purpose the SiO₂ particles, for example, can be prepared by the sol-gel process using at least one hydrolytically polycondensable silane having at least one polymerizable and/or polycondensable group. Suitable such silanes include, for example, the above-described silanes of the formula (I). These silanes are used either alone or in combination with a suitable silane of the formula (II):

SiR²₄ (II)

in which R² is as defined above. Preferred silanes of the above formula (II) are tetramethoxysilane and tetraethoxysilane.

In addition to or alternatively to the silanes of the formula (II) it is of course also possible to use other hydrolyzable silanes, examples being those which possess at least one nonhydrolyzable hydrocarbon group without a polymerizable and/or polycondensable group, such as methyl- or phenyltrialkoxysilanes, for example. These may be silanes of the formula (III):

R⁴ₙSiR²₄₋ₙ (III)

in which R² is as defined above and the nonhydrolyzable radical R⁴ is an alkyl group, preferably C₁₋₆ alkyl, such as methyl, ethyl, n-propyl, isopropyl, n-butyl, s-butyl and t-butyl, pentyl or hexyl, for example, a cycloalkyl group having 5 to 12 carbon atoms, such as cyclohexyl, or an aryl group, preferably C₆₋₁₀ aryl, such as phenyl or naphthyl, for example, and n is 1, 2 or 3, preferably 1 or 2, and especially 1. Said radical R⁴ may if desired have one or more customary substituents, such as halogen, ether, phosphoric acid, sulfonic acid, cyano, amido, mercapto, thioether or alkoxy groups, for example.

In the process of the invention a coating composition comprising the aforementioned nanoscale inorganic particulate solids is applied to the polymer film or to a layer which has already been applied. The applied coating composition is in particular a coating sol, i.e., a dispersion of the above-defined nanoscale inorganic particulate solids having polymerizable and/or polycondensable organic surface groups in a solvent or solvent mixture. The coating composition is fluid on application.

The solvent may be any solvent known to those of skill in the art. The solvent may be, for example, water and/or an organic solvent. The organic solvent is preferably miscible with water. Examples of suitable organic solvents are alcohols, ethers, ketones, esters, amides, and mixtures thereof. Preference is given to using alcohols, e.g., aliphatic or alicyclic alcohols, or alcohol mixtures, as solvent, preference being given to monohydric alcohols. Preferred alcohols are linear or branched monovalent alkanols having 1 to 8, preferably 1 to 6, carbon atoms. Particularly preferred alcohols are methanol, ethanol, n-propanol, 2-propanol, n-butanol, 2-butanol, isobutanol, tert-butanol or mixtures thereof.

The solvent or part of it may also be formed during the preparation of the nanoscale particles or during the surface modification. For example, the preparation of SiO₂ particles from alkoxysilanes is accompanied by liberation of the corresponding alcohols, which can then act as solvents.

It has surprisingly been found that the coating sols for the coating in accordance with the invention are especially suitable when they are used in highly diluted form for application. The total solids content of the coating sol to be applied is in particular not more than 20% by weight, preferably not more than 15% by weight and particularly preferably not more than 7% by weight. The total solids content is expediently at least 0.5% by weight, preferably at least 1% by weight and particularly preferably at least 2.5% by weight.

Provided the total solids content of the coating sol is not more than 20% by weight, excellent coatings can be obtained on the polymer films. If the coating sol is in a low dilution (i.e., has a relatively high total solids content), high wet film thicknesses of the coating cannot be achieved. Suitable wet film thicknesses of the applied coating sol are situated typically in the lower μm range, e.g., from 0.5 μm to 20 μm.

An additional constituent of the coating sol may be, for example, at least one monomeric or oligomeric species possessing at least one group which is able to react (undergo polymerization and/or polycondensation) with the polymerizable and/or polycondensable groups present on the surface of the nanoscale particles. Suitable such species include, for example, monomers having a polymerizable double bond, such as acrylates, methacrylates, styrene, vinyl acetate, and vinyl chloride, for example. Preferred monomeric compounds having more than one polymerizable bond are, in particular, those of the formula (IV):

(CH₂═CR³—COZ—)ₘ-A (IV)

in which
m=2, 3 or 4, preferably 2 or 3, and especially 2,
Z=O or NH, preferably O,

### R³═H, CH₃,

A=m-valent hydrocarbon radical which has 2 to 30, especially 2 to 20, carbon atoms and can contain one or more heteroatom groups located in each case between two adjacent carbon atoms (examples of such heteroatom groups are O, S, NH, NR(R=hydrocarbon radical), preferably O).

The hydrocarbon radical A may also carry one or more substituents selected preferably from halogen (especially F, CI and/or Br), alkoxy (especially C₁₋₄ alkoxy), hydroxyl, unsubstituted or substituted amino, NO₂, OCOR⁵, COR⁵ (R⁵═C₁₋₆ alkyl or phenyl). Preferably, however, the radical A is unsubstituted or is substituted by halogen and/or hydroxyl.

In one embodiment of the present invention A is derived from an aliphatic diol, an alkylene glycol, a polyalkylene glycol, or an optionally alkoxylated (e.g., ethoxylated) bisphenol (e.g., bisphenol A).

Further useful compounds having more than one double bond are, for example, allyl (meth)acrylate, divinylbenzene, and diallyl phthalate. Similarly, for example, a compound having two or more epoxy groups can be used (in the case where epoxide-containing surface groups are used), e.g., bisphenol A diglycidyl ether, or else an (oligomeric) precondensate of an epoxy-functional hydrolyzable silane such as glycidoxypropyltrimethoxysilane.

The fraction of organic components in the coating sols used in accordance with the invention is preferably not more than 20 percent by weight, e.g., from 4 to 15% by weight, based on the total solids content. For layers of high refractive index, for example, it can be 5 percent by weight, for layers with low refractive index, for example, 15 percent by weight. Preferably, however, no such organic components are used.

If desired, further additives, customary for film coatings, may also be added to the coating sol. Examples are thermal or photochemical crosslinking initiators, sensitizers, wetting auxiliaries, adhesion promoters, leveling agents, antioxidants, stabilizers, crosslinking agents and metal colloids, e.g., as carriers of optical functions. Besides the thermal or photochemical crosslinking initiators which may be used, and which are elucidated later on, however, the coating sol contains no further components; in other words, the coating sol or coating composition consists preferably of the nanoscale particulate solids having polymerizable and/or polycondensable organic surface groups, the solvent or solvents, and, if desired, one or more thermal or photochemical crosslinking initiators.

Unlike other rigid substrates, films are flexible and therefore require special coating techniques and coating compositions. The polymer film to be coated may be a conventional film customary in the art, for example a film of limited length or preferably an endless film (continuous film). Specific examples are films of polyethylene, e.g., HDPE or LDPE, polypropylene, polyisobutylene, polystyrene, polyvinyl chloride, polyvinylidene chloride, polytetrafluoroethylene, polychlorotrifluoroethylene, poly(meth)acrylates, polyamide, polyethylene terephthalate, polycarbonate, regenerated cellulose, cellulose nitrate, cellulose acetate, cellulose triacetate (TAC), cellulose acetate butyrate or rubber hydrochloride. The polymer film is preferably transparent. It is of course also possible to use composite films formed, for example, from the materials mentioned above.

The polymer film may have been pretreated. Prior to coating in accordance with the invention it may undergo, for example, a corona treatment or may be provided with a precoat, in order for example to promote adhesion, as scratch resistant coating or as an antiglare coating.

In step a) of the process of the invention the coating sol is applied to the polymer film by a film coating process in order to coat all or part of said film (on one side). Coating takes place on individual film sections or, preferably, in a continuous coating process. Suitable coating processes are the conventional film coating processes known to those of skill in the art. Examples thereof are knife coating (doctor blade coating processes), slot die coating, kiss coating with spiral scrapers, meniscus coating, roll coating or reverse-roll coating.

For the process of the invention, reverse-roll coating has proven particularly appropriate. In this process, the coating sol is taken up by a dip roll and transferred via a meniscus coating step, using a transfer roll, to a pressure roll (master roll). Given appropriately high precision of the rolls and of the drives, the nip between two rolls is sufficiently constant. The wet film present on the pressure roll is then deposited, usually completely, on the substrate film. As a result, the thickness of the wet film deposited on the substrate film is independent of any fluctuations in the thickness of the substrate film. Through the use of the reverse-roll process it is possible, surprisingly, to apply particularly precise and uniform multilayer interference systems to polymer films, and so the use of this process constitutes one particularly preferred embodiment of the process of the invention.

Before being applied to this film, the coating sol can be adjusted to a suitable viscosity or to a suitable solids content by means, for example, of addition of solvent. This involves preparation in particular of the highly diluted coating sols set out above. Application may be followed by a drying step, particularly when crosslinking is not carried out by a heat treatment.

In step b) of the process of the invention, the polymerizable and/or polycondensable surface groups of the nanoscale inorganic particulate solids, are crosslinked (where appropriate by way of the polymerizable and/or polycondensable groups of the monomeric or oligomeric species additionally used). Crosslinking may be carried out by means of customary polymerization and/or polycondensation reactions in the manner familiar to the skilled worker.

Examples of suitable crosslinking methods are thermal and photochemical (e.g., UV) crosslinking, electron beam curing, laser curing or room-temperature curing. Crosslinking takes place where appropriate in the presence of a suitable catalyst or initiator, which is added to the coating sol no later than immediately before application to the film.

Suitable initiators/initiator systems include all commonplace initiators/initiator systems known to the skilled worker, including free-radical photoinitiators, free-radical thermoinitiators, cationic photoinitiators, cationic thermoinitiators, and any desired combinations thereof.

Specific examples of free-radical photoinitiators which can be used include Irgacure® 184 (1-hydroxycyclohexyl phenyl ketone), Irgacure® 500 (1-hydroxycyclohexyl phenyl ketone, benzophenone), and other Irgacure® photoinitiators available from Ciba-Geigy; Darocur® 1173, 1116, 1398, 1174, and 1020 (available from Ciba-Geigy); benzophenone, 2-chlorothioxanthone, 2-methylthioxanthone, 2-isopropylthioxanthone, benzoin, 4,4′-dimethoxybenzoin, benzoin ethyl ether, benzoin isopropyl ether, benzil dimethyl ketal, 1,1,1-trichloroacetophenone, diethoxyacetophenone, and dibenzosuberone.

Examples of free-radical thermoinitiators include organic peroxides in the form of diacyl peroxides, peroxydicarbonates, alkyl peresters, alkyl peroxides, perketals, ketone peroxides, and alkyl hydroperoxides, and also azo compounds. Specific examples that might be mentioned here include, in particular, dibenzoyl peroxide, tert-butyl perbenzoate, and azobisisobutyronitrile. Where epoxy groups are present for the crosslinking it is possible to use, as thermoinitiators, compounds containing amine groups. An example is an aminopropyltrimethoxysilane.

One example of a cationic photoinitiator is Cyracure® UVI-6974, while a preferred cationic thermoinitiator is 1-methylimidazole.

These initiators may be used in the normal amounts known to the skilled worker, e.g., from 0.01 to 5% by weight, in particular from 0.1 to 2% by weight, based on the total solids content of the coating sol. In some cases it is of course possible in certain circumstances to do without the initiator entirely.

The crosslinking in step b) of the process of the invention takes place preferably thermally or by irradiation (in particular with UV light). Conventional light sources can be used for photopolymerization, especially sources which emit UV light, e.g., mercury vapor lamps, xenon lamps and laser light. In the case of crosslinking by way of heat treatment the appropriate temperature range depends naturally in particular on the polymerizable and/or polycondensable surface groups of the nanoscale inorganic particulate solids, on any initiators used, on the degree of dilution, and the duration of the treatment.

Generally speaking, however, heat treatment for crosslinking takes place within a temperature range from 80° C. to 200° C. and preferably from 100 to 140° C. The duration of the treatment may be, for example, from 30 s to 5 min, preferably from 1 min to 2 min. Step b) is performed such that at least partial crosslinking has taken place by way of the polymerizable and/or polycondensable surface groups; it is also possible for substantially all, if not all, of the polymerizable and/or polycondensable surface groups to be consumed by reaction for the crosslinking in this step.

In the course of heat treatment, further volatile constituents, especially the solvent, may evaporate from the coating composition before, during or after crosslinking, generally at the same time as crosslinking. Where no heat treatment is carried out for crosslinking, a heat treatment (for drying) may be performed following crosslinking.

The rate at which the coating composition is applied is chosen, as a function of the desired refractive index and field of application, generally in such a way as to obtain dry film thicknesses in the range from 50 to 200 nm, preferably from 100 to 150 nm.

In accordance with steps c) and d) and, where appropriate, e), one or more further layers are applied to the at least partly organically crosslinked layer formed, in analogy to steps a) and b), until the desired assembly of layers is obtained. In the case of the last (topmost) layer there is no longer absolute need for a separate crosslinking step as per b) and/or d); instead, crosslinking can be carried out, if desired, directly together with the final heat treatment step f), carried out where appropriate, for aftertreating the layer assembly.

The layer assembly is heat-treated if desired in step f). Carrying out this heat treatment of the layer assembly is preferred. The heat treatment gives a harder coating. The heat treatment depends naturally on the film and on the composition of the layers. Generally speaking, however, the final heat treatment takes place at temperatures in the range from 80 to 200° C., preferably from 100 to 160° C. and in particular from 110 to 130° C. The duration of the heat treatment is, for example, from 10 min to 2 h, preferably from 30 min to 1 h. This gives multilayer interference systems on polymer film without cracking or other defects.

Within the layers and/or within the layer assembly, the final heat treatment of the layer assembly may lead, for example, to substantial completion of the organic crosslinking or, where appropriate, may remove any residues of solvent present. During the heat treatment there are presumably also condensation reactions between the reactive groups still present on the surface of the particulate solids (e.g., (Si)—OH groups on SiO₂ particles), so that the solids particles within the layers are linked to one another by inorganic condensation reactions as well as the organic crosslinking discussed above.

In one particularly preferred embodiment it is possible to select the coating compositions such that, in the finished polymer film with multilayer interference system, residual reflection values of below 0.5% in the range between 400 nm and 650 nm wavelength, and residual reflection values below 0.3% at a wavelength of 550 nm, are obtained.

Depending on the end application, further treatment steps may follow. On the side opposite the side bearing the multilayer system, for example, the coated film may be provided with an adhesive layer and, where appropriate, with a top layer. The adhesive layer may serve, for example, for lamination to a substrate. A continuous film can be cut to size in order to obtain dimensions suitable for the end application.

The polymer film of the invention with multilayer interference system applied thereto is particularly suitable as an optical laminating film, for example on films and rigid substrates. Accordingly, the invention also provides a composite material comprising a substrate, which is preferably rigid, preferably composed of glass or plastic and/or is preferably transparent, onto which the polymer film of the invention is laminated. The substrate can of course also be provided with an optical laminating film on both sides.

Suitable laminating techniques are known to those of skill in the art, and any customary laminating techniques can be employed. Joining takes place, for example, by way of an adhesive layer, which may be applied to the film, to the substrate, or to both.

The polymer films with multilayer interference system produced in accordance with the invention, or the corresponding composite materials, are suitable, for example, as antireflection systems, especially to reduce glare, as reflection systems, reflection filters, and color filters for lighting purposes or for decorative purposes.

Examples of specific applications for the polymer films with multilayer interference system produced in accordance with the invention, and the corresponding composite materials, include the following:
antireflection systems and antireflection coatings for visible light in the field of architecture, e.g., screens or windows in buildings, glazing for shop windows and pictures, for glasshouses, for glazing within vehicles, e.g., automobiles, trucks, motorbikes, boats, and aircraft;
coated films in roll form with optical and/or decorative effect, lamination on nontransparent substrates for decorative purposes;
NIR (near infrared) reflection filters;
antiglare coating (NIR, Vis), e.g., for photovoltaic and other optical applications (solar cells, solar collectors);
color filters for lighting or for decorative purposes;
IR reflection coat for fire protection and heat protection applications;
UV reflection film; and
laser mirrors.

### DETAILED DESCRIPTION OF THE INVENTION

The following example serves to illustrate the invention further and is not limiting in nature.

### EXAMPLE

### Production of a Triple Antireflection Coat

### 1. Synthesis of the Coating Sols

The antireflection coating sols M, H, and L (M: sol for layer with medium refractive index, H: sol for layer with high refractive index, L: sol for layer with low refractive index) were prepared from three base sols (H, Lr, and Lo).

1.1. Synthesis of the Base Sols (Room Temperature)

### a) Base sol H

12.12 g of HCl (16.9%) was added to a mixture of 400 g of 2-propanol and 400 g of 1-butanol. 79.61 g of titanium isopropoxide was added with stirring to the solvent mixture. Synthesis is complete after stirring for 24 hours.

### b) Base Sol Lr

105.15 g of tetraethoxysilane was dissolved in 60 g of ethanol. Additionally, a solution was prepared from 41.5 g of HCl (0.69%) and 60 g of ethanol and was added with stirring to the tetraethoxysilane/ethanol mixture. After a reaction time of 2 hours the sol was diluted with 500 g of 2-propanol and 500 g of 1-butanol.

### c) Base Sol Lo

360.8 g of tetramethoxysilane was dissolved in 319.2 g of ethanol. Additionally, a solution was prepared from 6.9 g of HCl (37%), 362.5 g of water and 319.2 g of butanol. This solution was added with stirring to the tetramethoxysilane/ethanol mixture. Synthesis is complete after stirring for 2 hours.

1.2. Preparation of the Coating Sols (about 1 l of sol)

### a) Sol M

76.8 g of base sol Lr was mixed with 419.2 g of base sol H. 2.976 g of 1,4-cyclohexanedimethanol diglycidyl ether (CHMG) was added dropwise with stirring to this mixture. The sol was diluted with 321.6 g of 1-butanol.

### b) Sol H

1.2 g of 1,4-cyclohexanedimethanol diglycidyl ether (CHMG) was added dropwise with stirring to 480 g of base sol H. The sol was diluted with 321.6 g of 1-butanol.

### c) Sol L

201.6 g of base sol Lo was diluted with 624 g of 1-butanol. 1.44 g of prehydrolyzed glycidyloxypropyltrimethoxysilane (hydrolysis with 0.1 N HCl (0.5 mol/mol OR)) was added to this mixture, and then the solvent was removed on a rotary evaporator. Additionally, 0.072 g of aminopropyltrimethoxysliane, as thermoinitiator, was added to this mixture.

### 2. Coating of the Polymer Film

The polymer film used was a triacetate (TAC) film having a thickness of 50 μm and a scratch-resistant coating. The above coating sols M, H, and L were applied to the polymer film in succession with the aid of a reverse-roll coating unit (model BA 12300, Werner Mathis AG, Switzerland). The film tension for all 3 coatings is 60 N. Initial crosslinking of all three applied coatings was carried out at an oven temperature of 120° C. for a period of 2 min. For post-treatment the applied layer assembly in roll form was treated in a preheated oven at 120° C. for 30 minutes, then removed and cooled to room temperature. The result was a flawless multilayer interference system on the polymer film, having the desired interference behavior.

For the application of the 3 layers the following coating parameters were set for the reverse-roll coating:

| | | | Speed | |
|---|---|---|---|---|
| Sol | Roller | Rotation | (m/min) | Nip (μm) |
| M | Dip roller | left | 1.0 | |
| | Transfer roller | left | 1.0 | Between dip and transfer |
| | | | | roll = 100 |
| | Master roller | right | 1.0 | Between transfer and |
| | | | | master roll = 100 |
| H | Dip roller | left | 1.0 | |
| | Transfer roller | left | 1.0 | Between dip and transfer |
| | | | | roll = 150 |
| | Master roller | right | 1.0 | Between transfer and |
| | | | | master roll = 100 |
| L | Dip roller | left | 1.0 | |
| | Transfer roller | left | 1.0 | Between dip and transfer |
| | | | | roll = 100 |
| | Master roller | right | 1.0 | Between transfer and |
| | | | | master roll = 100 |

What is claimed is:

1. A polymer film with a multilayer optical interference system, wherein the interference system comprises three layers of different refractive index, each of the three layers comprising nanoscale inorganic particles comprised of at least one of SiO₂, TiO₂, ZrO₂, ZnO, Ta₂O₅, SnO2, and Al₂O₃ and having organic surface groups that are at least one of polymerizable and polycondensable and comprise at least one of an acryloyl, a methacryloyl, a vinyl, an allyl, and an epoxy group, and wherein the layers are at least partially crosslinked through the organic surface groups.

2. The polymer film of claim 1, wherein the nanoscale inorganic particles comprise particles of at least one of SiO₂ and TiO₂.

3. The polymer film of claim 1, wherein the average particle size of the inorganic particles is from 5 nm to 20 nm.

4. The polymer film of claim 1, wherein each of the three layers has a dry film thickness of from 50 nm to 200 nm.

5. The polymer film of claim 3, wherein each of the three layers has a dry film thickness of from 100 nm to 150 nm.

6. The polymer film of claim 1, wherein the polymer film comprises at least one of polyethylene, polypropylene, polyisobutylene, polystyrene, polyvinyl chloride, polyvinylidene chloride, polytetrafluoroethylene, polychlorotrifluoroethylene, poly(meth)acrylate, polyamide, polyethylene terephthalate, polycarbonate, regenerated cellulose, cellulose nitrate, cellulose acetate, cellulose triacetate (TAC), cellulose acetate butyrate and rubber hydrochloride.

7. The polymer film of claim 6, wherein the polymer film has a residual reflection of below 0.5% in a wavelength range of between 400 nm and 650 nm and a residual reflection of below 0.3% at a wavelength of 550 nm.

8. A polymer film coated with a multilayer optical interference system, wherein the optical interference system comprises at least two partially crosslinked layers of different refractive index and each layer is obtained by (a) application of a coating composition which comprises nanoscale inorganic particles comprised of at least one of SiO₂, TiO₂, ZrO₂, ZnO, Ta₂O₅, SnO₂, and Al₂O₃ having an average particle size of not higher than 70 nm and comprising organic surface groups that are at least one of polymerizable and polycondensable, and (b) at least partially crosslinking the applied coating composition through the organic surface groups to form the partially crosslinked layer.

9. The polymer film of claim 8, wherein the organic surface groups are selected from organic radicals which comprise at least one of an acryloyl, a methacryloyl, a vinyl, an allyl and an epoxy group.

10. A composite material comprising a multilayer optical interference system, wherein the composite material comprises a transparent substrate with the polymer film of claim 1 arranged thereon.

11. An antireflection system or reflection system which comprises the polymer film of claim 1.

12. A reflection filter or color filter which comprises the polymer film of claim 1.

13. A process for producing a polymer film having thereon a multilayer interference assembly which comprises at least two layers having different refractive indices, wherein the process comprises:
(a) applying a first coating sol which comprises nanoscale inorganic particles comprised of at least one of SiO₂, TiO₂, ZrO₂, ZnO, Ta₂O₅, SnO₂, and Al₂O₃ and comprising organic surface groups that are at least one of polymerizable and polycondensable and comprise at least one of an acryloyl, a methacryloyl, a vinyl, an allyl, and an epoxy group on the polymer film;
(b) reacting at least a part of the organic surface groups to form a first layer which is at least partially crosslinked;
(c) applying a second coating sol which comprises nanoscale inorganic particles comprised of at least one of SiO₂, TiO₂, ZrO₂, ZnO, Ta₂O₅, SnO₂, and Al₂O₃ and comprising organic surface groups that are at least one of polymerizable and polycondensable and comprise at least one of an acryloyl, a methacryloyl, a vinyl, an allyl, and an epoxy group on the first layer;
(d) reacting at least a part of the organic surface groups in the second sol to form an at least partially crosslinked second layer on the first layer;
optionally, repeating (c) and (d) at least one more time to produce a multilayer assembly which comprises at least three at least partially crosslinked layers with different refractive indices; the process comprising a heat treatment of the multilayer assembly, which heat treatment is carried out at a temperature of from 80° C. to 200° C. concurrently with an at least partial crosslinking of an uppermost layer of the multilayer assembly.

14. The process of claim 13, wherein at least one of the first and second coating sols has a total solids content of not more than 7% by weight.

15. The process of claim 13, wherein the at least partially crosslinked layers are formed at a temperature of from 100° C. to 140° C.

16. The process of claim 13, wherein the nanoscale inorganic particles comprise particles of at least one of SiO₂ and TiO₂.

17. The process of claim 16, wherein the average particle size of the inorganic particles is from 5 nm to 20 nm.

18. The process of claim 17, wherein the coating sols consist essentially of the nanoscale inorganic particles, one or more solvents and, optionally, one or more crosslinking initiators selected from thermal and photochemical initiators.

19. The process of claim 17, wherein the coating sols are applied at a wet film thickness of from 0.5 μm to 20 μm.

20. The process of claim 13, wherein the process comprises applying at least one coating sol by reverse-roll coating.
